(19) United States
(12) Patent Application Publication
(10) Pub. No.: US 2021/0165124 A1
(43) Pub. Date: Jun. 3, 2021

(54) Modeling Geological Strata Using Weighted Parameters

(71) Applicant: Landmark Graphics Corporation, Houston, TX (US)

(72) Inventors: William C. Ross, Littletown, CO (US); Nicholas S. Tiedemann, Denver, CO (US); Steven B. Ward, Austin, TX (US); Andrzej Czeslaw Szymczak, Highlands Ranch, CO (US); Donald Nelson, Highlands Ranch, CO (US); Thomas Chester Daffin, Littletown, CO (US)

(21) Appl. No.: 15/775,646

(22) PCT Filed: Jun. 14, 2017
(86) PCT No.: PCT/US2017/037486

§ 371 Date: May 11, 2018

(51) Int. Cl. G01V 99/00; G06F 30/20

(52) U.S. Cl. CPC G01V 99/005; G06F 2111/10; G06F 30/20

(57) ABSTRACT

Geological stata can be modeled using weighted parameters. For example, geological data representative of strata in a subterranean formation can be received. A weight for a parameter usable to generate a geological model can be determined. Examples of the parameter can include (i) a first parameter for reducing a change in a thickness of a stratum, (ii) a second parameter for maintaining a minimum thickness of the stratum, (iii) a third parameter for maintaining a maximum thickness of the stratum, (iv) a fourth parameter for reducing a curvature in the thickness of the stratum, (v) a fifth parameter for a user-provided indication of a feature of the stratum, or (vi) any combination of these. The geological model can be generated by concurrently solving a system of equations using the weight and the geological data. The geological model can be displayed and can visually represent the cross-sectional shapes of the strata.

### TECHNICAL FIELD

The present disclosure relates generally to geological interpretation. More specifically, but not by way of limitation, this disclosure relates to modeling geological strata using weighted parameters.

### BACKGROUND

A well system (e.g., for extracting oil or gas) can include multiple wellbores drilled through a subterranean formation. Each wellbore can have a well logging tool that provides data in the form of a well log back to a well operator. A well log can be a record indicative of the geologic formations that are penetrated by a wellbore. The well operator can manually review the well logs to identify strata or other features of interest in the subterranean formation. For example, the well operator can manually review multiple well logs in a two-dimensional (2D) cross-sectional view or a three-dimensional (3D) view to identify structures or features of interest.

### BRIEF DESCRIPTION OF THE DRAWINGS

FIG. 1 is a cross-sectional side view of an example of a well system for obtaining well logs according to some aspects.

FIG. 2 is a cross-sectional side view of an example of a model of strata according to some aspects.

FIG. 3 is a block diagram of an example of a computing device according to some aspects.

FIG. 4 is flow chart of an example of a process for modeling geological strata using weighted parameters according to some aspects.

FIG. 5 is a flow chart of an example of a process for generating a geological model according to some aspects.

### DETAILED DESCRIPTION

Certain aspects and features of the present disclosure relate to generating a geological model of a subterranean formation by concurrently determining shapes of strata in the subterranean formation based on user-provided weights for parameters. The parameters can define requirements for the geological model. For example, the parameters can be geologic metrics usable for generating the geological model. And the user-provided weights can be values indicating the relative influences of the parameters on the geological model. In some examples, generating the geological model based on the user-provided weights for the parameters can enable the geological model to be customized in a manner that is most useful for the user. And because the shapes of strata are interrelated due to their layered positioning on one another, a geological model that accounts for these interrelationships by concurrently determining the shapes of the strata (as opposed to sequentially determining the shapes of the strata) can be more realistic and accurate.

In some examples, the parameters can include constraints for generating the model. Examples of the constraints can include that (i) a gradient in a thickness of a stratum is to be minimized, (ii) a minimum thickness of a stratum is to be maintained, (iii) a maximum thickness of a stratum is to be maintained, (iv) a curvature in the thickness of a stratum is to be minimized, (v) a user-provided indication of a feature of the stratum is to be respected, (vi) surfaces of the strata are not to cross each other, or (vii) any combination of these. One specific example of a constraint can include a regional thickness constraint that forces the thicknesses of the strata to remain substantially consistent over the region of the subterranean formation being modeled. This may be useful when modeling, for example, a topset region of the subterranean formation. The topset region can include a nonmarine-to-shallow marine region of a basin fill, and may exhibit consistent thicknesses over long distances as a result of the long-wavelength subsidence trends that control the thickness of the topset region. By invoking (or heavily weighting) the regional thickness constraint, a more realistic and accurate model of the topset region may be generated.

The shapes for the strata can be determined concurrently using a system of equations. For example, a computing device can include multiple quadratic functions to be solved concurrently to determine thicknesses, surface shapes, or both of the strata. The quadratic functions can also take into account the user-provided weights for the parameters. The computing device can solve the quadratic functions together to determine the shapes of the strata. The computing device can then form the geological model using the determined shapes of the strata.

In some examples, a user can set a priority of a first parameter over a second parameter, such that the first parameter is to be honored over the second parameter (e.g., if the two parameters conflict). The geological model can then be generated based on this prioritization. For example, a computing device can receive user input indicating that a parameter for minimizing a change in a thickness of a stratum is to be prioritized over another parameter for maintaining a minimum thickness for the stratum. Based on this prioritization, if these two parameters conflict while generating the geological model, the computing device will ensure that the change in the thickness of the stratum is minimized. As another example, the computing device can receive user input identifying a feature of a stratum, such as a surface of the stratum. The user input can be used as a parameter. The computing device can also receive user input indicating that this parameter is to be prioritized over another parameter for minimizing a change in the thickness of a stratum. Based on this prioritization, if these two parameters conflict while generating the geological model, the computing device will ensure that the user input is respected.

Some examples of the present disclosure can provide enhanced geological models that reduce or eliminate the presence of crossing stratum-surfaces, strata that have rapidly changing thicknesses (e.g., where they become too thick or too thin), and other problems resulting from mismatched, disparate, or incongruous pieces of data.

These illustrative examples are given to introduce the reader to the general subject matter discussed here and are not intended to limit the scope of the disclosed concepts. The following sections describe various additional features and examples with reference to the drawings in which like numerals indicate like elements, and directional descriptions are used to describe the illustrative aspects but, like the illustrative aspects, should not be used to limit the present disclosure.

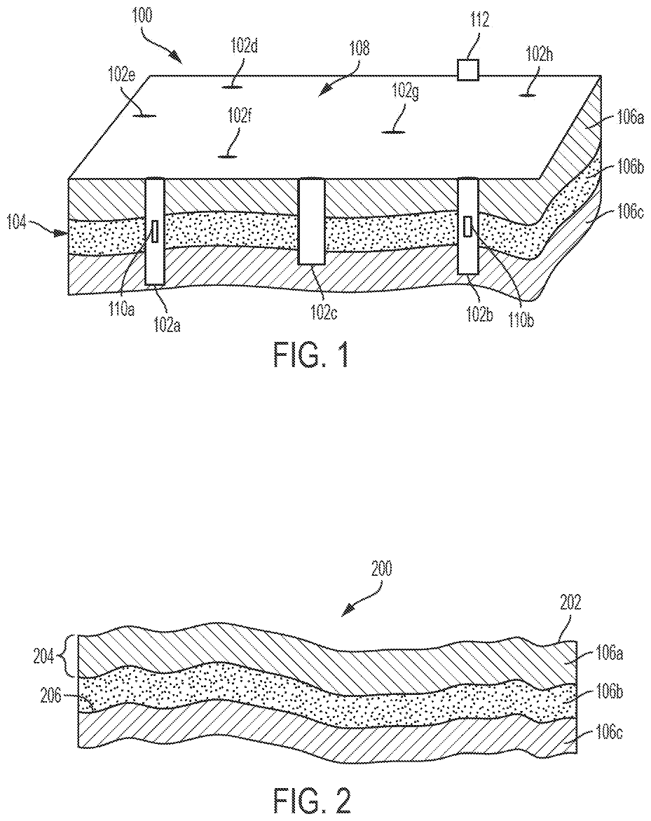

FIG. 1 is a cross-sectional side view of an example of a well system 100 for obtaining well logs according to some aspects. The well system 100 includes multiple wellbores 102a-h drilled through a subterranean formation 104. The wellbores 102a-h extend from the well surface 108 into strata 106a-c of the subterranean formation 104. The strata 106a-c can include different materials (e.g., rock, soil, oil, water, or gas) and vary in thickness and shape.

Some or all of the wellbores 102a-h can include well tools, such as logging tools 110a-b, for generating the well logs. Each of the well tools can measure properties of the rocks, fluid, or other contents of the strata 106a-c and use the measured properties to generate a respective well log. For example, the logging tool 110a can measure the electrical, acoustic, radioactive, electromagnetic, or pressure properties of the strata regions proximate to wellbore 102a. The logging tool 110a can then use the measurements to generate a well log. A separate well log can be generated for each of the wellbores 102a-h.

The well tools can electronically communicate the well logs to a computing device 112, which can be positioned onsite (as shown in FIG. 1) or offsite. The well tools can electrically communicate with the computing device 112 via a wired or wireless interface. In some examples, the well tools can electronically communicate the well logs to the computing device 112 indirectly, such as over the Internet or another network.

The computing device 112 can use the well logs or other geological data to generate a geological model. The geological model can be a two-dimensional (2D) or three-dimensional (3D) representation of at least a portion of the subterranean formation 104. One example of such a geological model is shown in FIG. 2. The geological model 200 includes a visual representation of a cross-section of the strata 106a-c in the subterranean formation 104. Each of the strata 106a-c in the cross-section has a thickness and a surface. For example, stratum 106a has thickness 204 and stratal surface 202. In some examples, a stratal surface can define a boundary between two of the strata 106a-c. For example, stratal surface 206 can define a boundary between stratum 106b and stratum 106c. The thicknesses and the surface shapes of the strata 106a-c can provide useful information about the subterranean formation 104.

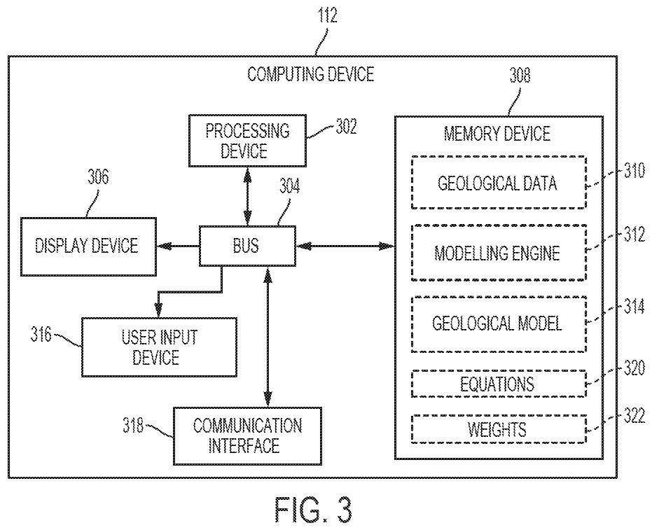

One example of the computing device 112 is shown in FIG. 3. The computing device 112 can include a processing device 302, a bus 304, a display device 306, a memory device 308, a user input device 316, and a communication interface 318. In some examples, some or all of the components shown in FIG. 3 can be integrated into a single structure, such as a single housing. In other examples, some or all of the components shown in FIG. 3 can be distributed (e.g., in separate housings) and in electrical communication with each other.

The processing device 302 can execute one or more operations for modeling geological strata using weighted parameters. The processing device 302 can execute instructions stored in the memory device 308 to perform the operations. The processing device 302 can include one processing device or multiple processing devices. Non-limiting examples of the processing device 302 include a Field-Programmable Gate Array (“FPGA”), an application-specific integrated circuit (“ASIC”), a microprocessing device, etc.

The processing device 302 can be communicatively coupled to the memory device 308 via the bus 304. The non-volatile memory device 308 may include any type of memory device that retains stored information when powered off. Non-limiting examples of the memory device 308 include electrically erasable and programmable read-only memory (“EEPROM”), flash memory, or any other type of non-volatile memory. In some examples, at least some of the memory device 308 can include a medium from which the processing device 302 can read instructions. A computer-readable medium can include electronic, optical, magnetic, or other storage devices capable of providing the processing device 302 with computer-readable instructions or other program code. Non-limiting examples of a computer-readable medium include (but are not limited to) magnetic disk(s), memory chip(s), read-only memory (ROM), random-access memory (“RAM”), an ASIC, a configured processing device, optical storage, or any other medium from which a computer processing device can read instructions. The instructions can include processing device-specific instructions generated by a compiler or an interpreter from code written in any suitable computer-programming language, including, for example, C, C++, C#, etc.

In some examples, the memory device 308 can include geological data 310, such as well logs or seismic data). The geological data 310 can be communicated to the computing device 112 from one or more well tools positioned in one or more wellbores.

In some examples, the memory device 308 can include a modelling engine 312. The modelling engine 312 can be a software application for modeling geological strata using weighted parameters. More specifically, the modelling engine 312 may be able to receive or generate weights 322 for parameters. Some or all of the parameters can be constraints. The modelling engine 312 can then use the weights 322 for the parameters to determine shapes (e.g., cross-sectional shapes, surface shapes, thicknesses, or any combination of these) of strata in a subterranean formation. In some examples, the modelling engine 312 can determine the surface shapes and thicknesses of all the strata substantially simultaneously to one another. The modelling engine 312 can generate a geological model 314 based on the surface shapes and thicknesses for the strata.

The memory device 308 can also include equations 320 for generating the geological model 314. Although the equations 320 are shown separately from the modelling engine 312 in this example, in other examples the modelling engine 312 can include the equations 320. The equations 320 can form a system of equations that may be solved concurrently. For example, the equations 320 can depend on one another so that each equation affects the entire system of equations. Constraints placed on the equations 320, and parameter values, may also affect the entire system of equations.

The computing device 112 can include a user input device 316. The user input device 316 can represent one or more components used to input data. Examples of the user input device 316 can include a keyboard, mouse, touchpad, button, or touch-screen display, etc.

The computing device 112 can include a display device 306. The display device 306 can represent one or more components used to output data. Examples of the display device 306 can include a liquid-crystal display (LCD), a television, a computer monitor, a touch-screen display, etc. In some examples, the user input device 316 and the display device 306 can be a single device, such as a touch-screen display.

The computing device 112 can include a communication interface 318. The communication interface 318 can represent one or more components that facilitate a network connection or otherwise facilitate communication between electronic devices. Examples include, but are not limited to, wired interfaces such as Ethernet, USB, IEEE 1394, and/or wireless interfaces such as IEEE 802.11, Bluetooth, near-field communication (NFC) interfaces, RFID interfaces, or radio interfaces for accessing cellular telephone networks (e.g., transceiver/antenna for accessing a CDMA, GSM, UMTS, or other mobile communications network).

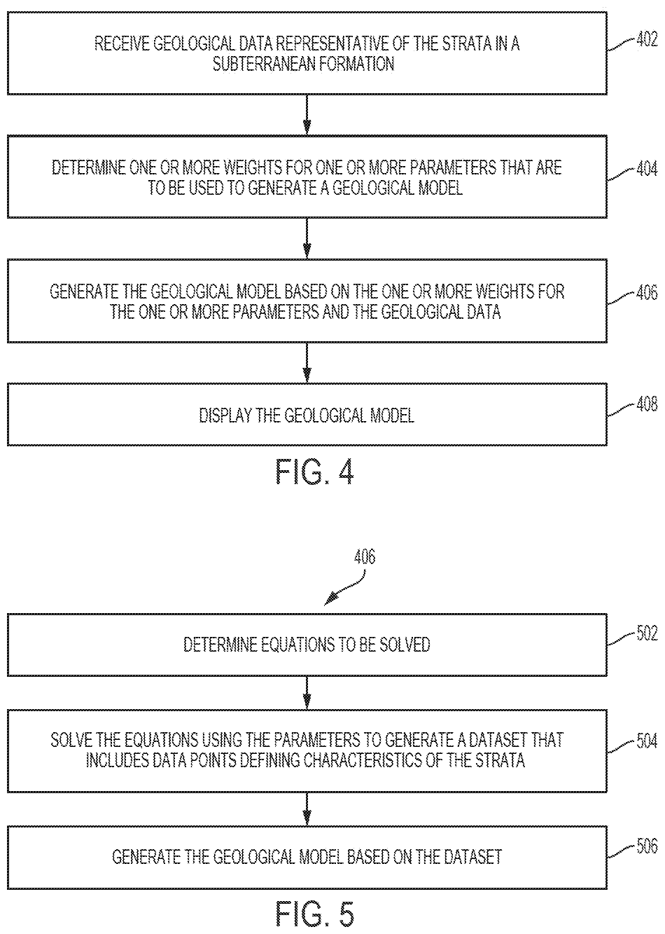

In some examples, the computing device 112 can implement one or more of the steps shown in FIG. 4 for modeling geological strata using weighted parameters. The computing device 112 may alternatively implement a process that has more steps, fewer steps, different steps, or a different order of the steps depicted in FIG. 4. The steps below are described with reference to the components of FIG. 3 discussed above.

In block 402, the computing device 112 receives geological data 310 representative of the strata in a subterranean formation. The computing device 112 can receive the data from a well tool, a remote database, or a local memory device 208. The geological data 310 can be a well log, seismic data, or other data associated with strata in the subterranean formation 104.

In block 404, the computing device 112 determines one or more weights 322 for one or more parameters that are to be used to generate a geological model 315. In some examples, the weights 322 for the parameters are provided as user input via user input device 316. In other examples, the weights 322 can be determined using other methods. For example, the weights 322 for the parameters can be determined (e.g., automatically) by a software application that is local to, or remote from, the computing device 112. An example of the software application can be the modelling engine 312. The computing device 112 can determine any number and combination of weights 322 for any number and combination of parameters.

Examples of the parameters can include (i) a first parameter for reducing a change in a thickness of a stratum, (ii) a second parameter for maintaining a minimum thickness of the stratum, (iii) a third parameter for maintaining a maximum thickness of the stratum, (iv) a fourth parameter for reducing a curvature in the thickness of the stratum, (v) a fifth parameter for a user-provided indication of a feature of the stratum, (vi) a sixth parameter for preventing stratal surfaces from crossing, or (vii) any combination of these. Examples of weights 322 for the parameters can be 0.25, 0.5, 0.75, and 1.0. Examples of the feature of the stratum can include a top surface of the stratum, a bottom surface of the stratum, a length of the stratum, a curvature in the stratum, a point within the stratum, or any combination of these.

The computing device 112 may additionally or alternatively determine priorities between two or more parameters. For example, the computing device 112 may output a graphical user interface through which a user can order parameters according to a desired priority. As another example, the priorities for the parameters can be determined (e.g., automatically) by a software application that is local to, or remote from, the computing device 112. The software application can prioritize the parameters according to predetermined rules provided by a manufacturer or distributor of the software application.

In block 406, the computing device 112 generates the geological model 314 based on the one or more weights 322 for the one or more parameters and the geological data 310. For example, the computing device 112 can generate the geological model by concurrently determining cross-sectional shapes of the strata by solving a system of equations using the weight for the parameter and the geological data. In some examples, the computing device 112 can execute the modelling engine 312 to generate the geological model 314. One method for generating the geological model 314 will be described in greater detail below with reference to FIG. 5.

In block 408, the computing device 112 displays the geological model 314. For example, the computing device 112 can output the geological model 314 using display device 306. The geological model 314 can visually represent various properties of the strata in the subterranean formation. The geological model 315 can include a 2D or 3D representation of the strata.

Other operations can additionally or alternatively be performed after generating the geological model 314 in block 406. For example, the computing device 112 or a well operator can control operation of a well tool, such as a drilling tool, based on the geological model 314. In one particular example, the computing device 112 can transmit electronic communications for steering a drilling tool to avoid a stratum having certain undesirable properties or to target a stratum having certain desirable properties. In some examples, the computing device 112 can communicate the geological model 314 to a remote computing device to control the remote computing device or for analysis by a remote user.

FIG. 5 is a flow chart of an example of a process for generating a geological model according to some aspects. Some examples can be implemented using more steps, fewer steps, different steps, or a different order of the steps depicted in FIG. 5. The steps below are described with reference to the components of FIG. 3 discussed above.

In block 502, the computing device 112 determines equations 320 to be solved. For example, the computing device 112 can receive some or all of the equations 320 from a local memory device 308, a remote memory device of a remote computing device, via user input, or any combination of these.

In some examples, the equations 320 include quadratic functions, or quadratic equations, and corresponding parameters. For example, the equations 320 can include a quadratic function representing the smoothness (e.g., curvature) of a surface of a stratum. Additionally or alternatively, the equations 320 can include another quadratic function representing a gradient of a thickness between two stratal surfaces. Each of the equations 320 can have one or more of the parameters associated with it.

In block 504, the computing device 112 solves the equations 320 using the parameters (e.g., using the weights 322 for the parameters). The computing device 112 can use any number and combination of techniques for solving the equations 320 using the parameters.

In some examples, the equations 320 can include a system of equations, such as a system of quadratic functions. The computing device 112 may solve the system of equations by optimizing (e.g., find a maximum value or a minimum value of) the system of equations. For example, the system of equations can be solved simultaneously as a global optimization problem. The global optimization problem may have the following form:
Minimize ½x^{T}Qx+c^{T}x subject to Ex≥d
   where Q can represent a matrix into which the weights 322 for the parameters are encoded; c can represent possible linear terms (e.g., constants or a constant vector); E can represent another matrix into which non-penetration constraints are encoded; T can indicate a transposition of the related variable; x can represent a final configuration of the strata for the geological model; and d can represent a vector of thicknesses. Each row r in matrix E can have a corresponding thickness in the r^{th} entry of d. In some examples, a non-penetration constraint can be a thickness constraint between two nodes i and j of adjacent strata. The entry for this thickness constraint in a row of E can be in the form [1 . . . −1 . . . ], and the row in d can have the desired thickness. Then, the equation Ex≥d can indicate that xᵢ>xⱼ+d (e.g., a nonpenetration or distance of at least d). In some examples, a result for the abovementioned global optimization problem can be determined by solving the system of equations using undetermined Lagrange multipliers, λ, as follows:

$$[ \begin{matrix}Q & {E}^{T} \\ E & 0\end{matrix} ] [ \begin{matrix}x \\ λ\end{matrix} ] = [ \begin{matrix}- c \\ d\end{matrix} ]$$

Additionally or alternatively, the system of equations can be solved simultaneously as a global dynamics problem. The system of equations can be quasi-static. In some examples, the system of equations can be solved by integrating a first-order ordinary differential equation for forces f, velicities v, and to determine the final configuration:

$$\frac{d}{d t} ( \begin{matrix}x \\ v\end{matrix} ) = ( \begin{matrix}v \\ {M}^{- 1} f ( x , v )\end{matrix} )$$

where M can represent a mass matrix. In some examples, M can be an identity matrix, as inertial effects can be ignored for the quasi-static case. The forces f can be a first derivative of energy (x′*Q*x), or f=Q*x. In some examples, the system of equations can be augmented using Lagrange multipliers to force the system of equations to respect hard constraints:

$$( \frac{\partial f}{\partial x} {M}^{- 1} \frac{\partial {f}^{T}}{\partial x} ) λ = - h {M}^{- 1} f$$

In some examples, equations in the system of equations can depend on one another. For example, a result from solving a first equation in the system of equations can be used as a value for a variable in a second equation in the system of equations. The computing device 112 can solve the second equation by solving the first equation. As a particular example, the system of equations can include at least two different equations, which can collectively define shapes for the strata. The at least two different equations can depend on each other. Each equation may, for example, define a different shape-characteristic of the strata. A shape-characteristic can be a characteristic of a shape of a stratum. The computing device 112 can solve the system of equations by first determining the result of the first equation, and then inserting the result into the second equation to solve the second equation.

The computing device 112 can solve the equations 320 to generate a dataset that includes data points defining characteristics of the strata. For example, the dataset can include data points that define the locations and shapes of stratal surfaces in the subterranean formation. The data points can additionally or alternatively define thicknesses of the strata in the subterranean formation. The data points can include X, Y, and Z coordinates.

In block 506, the computing device 112 generates the geological model 314 based on the dataset. For example, the computing device 112 can graphically render the dataset to visually represent the strata in as layers positioned adjacent to one another, with each layer having a defined thickness and surface shape. The geological model 314 may help a well operator or geologist visualize the physical characteristics of the subterranean formation.

In some examples, the computing device 112 can update the geological model 314 in response to new data. For example, the computing device 112 can receive new geological data representative of the strata in the subterranean formation. The new geological data can be received, for example, while a wellbore is being drilled or after a wellbore has been drilled. The computing device 112 can generate an updated version of the geological model by solving the equations 320 using the weights 322 for the parameters and the new geological data. For example, the computing device 112 can concurrently re-determine the shapes (e.g., surface shapes and thicknesses) for strata by solving a system of quadratic functions. The computing device 112 can then display the updated version of the geological model via the display device 306.

In some aspects, geological strata can be modeled using weighted parameters according to one or more of the following examples:

Example #1: A method for generating a geological model of strata in a subterranean formation can include receiving geological data representative of the strata in the subterranean formation. The method can include determining a weight for a parameter to be used to generate the geological model. The parameter can include (i) a first parameter for reducing a change in a thickness of a stratum, (ii) a second parameter for maintaining a minimum thickness of the stratum, (iii) a third parameter for maintaining a maximum thickness of the stratum, (iv) a fourth parameter for reducing a curvature in the thickness of the stratum, or (v) a fifth parameter for a user-provided indication of a feature of the stratum. The method can include concurrently determining cross-sectional shapes of the strata by solving a system of quadratic functions using the weight for the parameter and the geological data to generate the geological model. The method can include displaying, by a display device, the geological model. The geological model can visually represent the cross-sectional shapes of the strata.

Example #2: The method of Example #1 may include receiving the weight for the parameter from a user via a user input device. The method may include generating the geological model based on the weight for the parameter while ensuring that surfaces of the strata do not intersect with one another.

Example #3: The method of any of Examples #1-2 may feature the parameter including at least two different parameters. The method can include receiving a priority among the at least two different parameters from a user via a user input device. The method can include generating the geological model based on the priority among the at least two different parameters.

Example #4: The method of any of Examples #1-3 may include receiving new geological data representative of the strata in the subterranean formation. The method can include generating an updated version of the geological model by solving the system of quadratic functions using the weight for the parameter and the new geological data to concurrently re-determine the cross-sectional shapes of the strata. The method can include displaying the updated version of the geological model via the display device.

Example #5: The method of any of Examples #1-4 may feature the system of quadratic functions including at least two different quadratic functions that collectively define the cross-sectional shapes of the strata and have associated parameters. The at least two different quadratic functions can be dependent on one another. Each quadratic function of the at least two different quadratic functions can have at least one associated parameter and define a different shape-characteristic of the strata. The method can include concurrently determining the cross-sectional shapes of the strata by solving the at least two different quadratic functions subject to the associated parameters using Lagrange multipliers.

Example #6: The method of any of Examples #1-5 may feature the parameter including the first parameter.

Example #7: The method of any of Examples #1-6 may feature the parameter including the second parameter or the third parameter.

Example #8: The method of any of Examples #1-7 may feature the parameter including the fourth parameter. The cross-sectional shapes of the strata can include surface shapes and thicknesses of the strata.

Example #9: The method of any of Examples #1-8 may feature the parameter including the fifth parameter. The feature can include a surface of the stratum.

Example #10: A non-transitory computer-readable medium can include instructions for generating a geological model of strata in a subterranean formation. The instructions can be executable by a processing device. The instructions can cause the processing device to receive geological data representative of the strata in the subterranean formation. The instructions can cause the processing device to determine a weight for a parameter to be used to generate the geological model. The parameter can include (i) a first parameter for reducing a change in a thickness of a stratum, (ii) a second parameter for maintaining a minimum thickness of the stratum, (iii) a third parameter for maintaining a maximum thickness of the stratum, (iv) a fourth parameter for reducing a curvature in the thickness of the stratum, or (v) a fifth parameter for a user-provided indication of a feature of the stratum. The instructions can cause the processing device to concurrently determine cross-sectional shapes of the strata by solving a system of quadratic functions using the weight for the parameter and the geological data to generate the geological model. The instructions can cause the processing device to cause a display device to display the geological model. The geological model can visually represent the cross-sectional shapes of the strata.

Example #11: The non-transitory computer-readable medium of Example #10 may further include instructions that can cause the processing device to receive the weight for the parameter from a user via a user input device. The instructions can cause the processing device to generate the geological model based on the weight for the parameter while ensuring that surfaces of the strata do not intersect with one another.

Example #12: The non-transitory computer-readable medium of any of Examples #10-11 may further include instructions that can cause the processing device to receive a priority among at least two different parameters from a user via a user input device. The instructions can cause the processing device to generate the geological model based on the priority among the at least two different parameters.

Example #13: The non-transitory computer-readable medium of any of Examples #10-12 may feature the parameter including the first parameter and the fifth parameter. The feature can include a surface of the stratum.

Example #14: The non-transitory computer-readable medium of any of Examples #10-13 may further include instructions that can cause the processing device to solve the system of quadratic functions using a Lagrange multiplier corresponding to a constraint.

Example #15: The non-transitory computer-readable medium of any of Examples #10-14 may further include instructions that can cause the processing device to concurrently determine the cross-sectional shapes of the strata by determining a first surface shape of a first stratum in the strata substantially simultaneously to determining a second surface shape of a second stratum in the strata by solving the system of quadratic functions.

Example #16: The non-transitory computer-readable medium of any of Examples #10-15 may feature the system of quadratic functions including at least two different quadratic functions that collectively define the cross-sectional shapes of the strata. The non-transitory computer-readable medium can further include instructions that can cause the processing device to concurrently determine the cross-sectional shapes of the strata by solving the at least two different quadratic functions.

Example #17: A system for generating a geological model of strata in a subterranean formation can include a processing device and a memory device on which instructions executable by the processing device are stored. The instructions can cause the processing device to receive geological data representative of the strata in the subterranean formation. The instructions can cause the processing device to determine a weight for a parameter to be used to generate the geological model. The parameter can include (i) a first parameter for reducing a change in a thickness of a stratum, (ii) a second parameter for maintaining a minimum thickness of the stratum, (iii) a third parameter for maintaining a maximum thickness of the stratum, (iv) a fourth parameter for reducing a curvature in the thickness of the stratum, or (v) a fifth parameter for a user-provided indication of a feature of the stratum. The instructions can cause the processing device to concurrently determine cross-sectional shapes of the strata by solving a system of quadratic functions using the weight for the parameter and the geological data to generate the geological model. The instructions can cause the processing device to cause a display device to display the geological model. The geological model can visually represent the cross-sectional shapes of the strata.

Example #18: The system of Example #17 may feature the parameter including a plurality of parameters. The plurality of parameters can include the first parameter, the second parameter or the third parameter, and the fifth parameter.

Example #19: The system of any of Examples #17-18 may feature the memory device further including instructions executable by the processing device for causing the processing device to concurrently solving the system of quadratic functions using Lagrange multipliers corresponding to a plurality of constraints.

Example #20: The system of any of Examples #17-19 may feature the memory device further including instructions executable by the processing device for causing the processing device to concurrently solving the system of quadratic functions by: using a first quadratic function in the system of quadratic functions as a value for a variable in a second quadratic function in the system of quadratic functions, and solving the second quadratic function.

The foregoing description of certain examples, including illustrated examples, has been presented only for the purpose of illustration and description and is not intended to be exhaustive or to limit the disclosure to the precise forms disclosed. Numerous modifications, adaptations, and uses thereof will be apparent to those skilled in the art without departing from the scope of the disclosure.

1. A method for generating a geological mod& of strata in a subterranean formation, the method comprising:
receiving, by a processing device, geological data representative of the strata in the subterranean formation;
determining, by the processing device, a weight for a parameter to be used to generate the geological model, the parameter including (i) a first parameter for reducing a change in a thickness of a stratum, (ii) a second parameter for maintaining a minimum thickness of the stratum, (iii) a third parameter for maintaining a maximum thickness of the stratum, (iv) a fourth parameter for reducing a curvature in the thickness of the stratum, or (v) a fifth parameter for a user-provided indication of a feature of the stratum;
concurrently determining, by the processing device, cross-sectional shapes of the strata by solving a system of quadratic functions using the weight for the parameter and the geological data to generate the geological model; and
displaying, by a display device, the geological model, the geological model visually representing the cross-sectional shapes of the strata.

2. The method of claim 1, further comprising:
receiving the weight for the parameter from a user via a user input device; and
generating the geological model based on the weight for the parameter while ensuring that surfaces of the strata do not intersect with one another.

3. The method of claim 1, wherein the parameter includes at least two different parameters, and further comprising:
receiving a priority among the at least two different parameters from a user via a user input device; and
generating the geological model based on the priority among the at least two different parameters.

4. The method of claim 1, further comprising:
receiving new geological data representative of the strata in the subterranean formation;
generating an updated version of the geological model by solving the system of quadratic functions using the weight for the parameter and the new geological data to concurrently re-determine the cross-sectional shapes of the strata; and
displaying the updated version of the geological model via the display device.

5. The method of claim 1, wherein the system of quadratic functions includes at least two different quadratic functions that collectively define the cross-sectional shapes of the strata and have associated parameters, the at least two different quadratic functions being dependent on one another, each quadratic function of the at least two different quadratic functions having at least one associated parameter and defining a different shape-characteristic of the strata, and further comprising concurrently determining the cross-sectional shapes of the strata by solving the at least two different quadratic functions subject to the associated parameters using Lagrange multipliers.

6. The method of claim 1, wherein the parameter includes the first parameter.

7. The method of claim 1, wherein the parameter includes the second parameter or the third parameter.

8. The method of claim 1, wherein the parameter includes the fourth parameter, and the cross-sectional shapes of the strata include surface shapes and thicknesses of the strata.

9. The method of claim 1, wherein the parameter includes the fifth parameter, and the feature is a surface of the stratum.

10. A non-transitory computer-readable medium comprising instructions for generating a geological model of strata in a subterranean formation, the instructions being executable by a processing device for causing the processing device to:
receive geological data representative of the strata in the subterranean formation;
determine a weight for a parameter to be used to generate the geological model, the parameter including (i) a first parameter for reducing a change in a thickness of a stratum, (ii) a second parameter for maintaining a minimum thickness of the stratum, (iii) a third parameter for maintaining a maximum thickness of the stratum, (iv) a fourth parameter for reducing a curvature in the thickness of the stratum, or (v) a fifth parameter for a user-provided indication of a feature of the stratum;
concurrently determine cross-sectional shapes of the strata by solving a system of quadratic functions using the weight for the parameter and the geological data to generate the geological model; and
cause a display device to display the geological model, the geological model visually representing the cross-sectional shapes of the strata.

11. The non-transitory computer-readable medium of claim 10, further comprising instructions that are executable by the processing device for causing the processing device to:
receive the weight for the parameter from a user via a user input device; and
generate the geological model based on the weight for the parameter while ensuring that surfaces of the strata do not intersect with one another.

12. The non-transitory computer-readable medium of claim 10, further comprising instructions that are executable by the processing device for causing the processing device to:
receive a priority among at least two different parameters from a user via a user input device; and
generate the geological model based on the priority among the at least two different parameters.

13. The non-transitory computer-readable medium of claim 10, wherein the parameter includes the first parameter and the fifth parameter, and the feature is a surface of the stratum.

14. The non-transitory computer-readable medium of claim 10, further comprising instructions that are executable by the processing device for causing the processing device to solve the system of quadratic functions using a Lagrange multiplier corresponding to a constraint.

15. The non-transitory computer-readable medium of claim 10, further comprising instructions that are executable by the processing device for causing the processing device to concurrently determine the cross-sectional shapes of the strata by:
determining a first surface shape of a first stratum in the strata substantially simultaneously to determining a second surface shape of a second stratum in the strata by solving the system of quadratic functions.

16. The non-transitory computer-readable medium of claim 10, wherein the system of quadratic functions includes at least two different quadratic functions that collectively define the cross-sectional shapes of the strata, and further comprising instructions that are executable by the processing device for causing the processing device to concurrently determine the cross-sectional shapes of the strata by solving the at least two different quadratic functions.

17. A system for generating a geological model of strata in a subterranean formation, the system comprising:
a processing device; and
a memory device on which instructions executable by the processing device are stored for causing the processing device to:
receive geological data representative of the strata in the subterranean formation;
determine a weight for a parameter to be used to generate the geological model, the parameter including (i) a first parameter for reducing a change in a thickness of a stratum, (ii) a second parameter for maintaining a minimum thickness of the stratum, (iii) a third parameter for maintaining a maximum thickness of the stratum, (iv) a fourth parameter for reducing a curvature in the thickness of the stratum, or (v) a fifth parameter for a user-provided indication of a feature of the stratum;
concurrently determine cross-sectional shapes of the strata by solving a system of quadratic functions using the weight for the parameter and the geological data to generate the geological model; and
cause a display device to display the geological model, the geological model visually representing the cross-sectional shapes of the strata.

18. The system of claim 17, wherein the parameter includes a plurality of parameters, the plurality of parameters including the first parameter, the second parameter or the third parameter, and the fifth parameter.

19. The system of claim 18, wherein the memory device further includes instructions executable by the processing device for causing the processing device to concurrently solving the system of quadratic functions using Lagrange multipliers corresponding to a plurality of constraints.

20. The system of claim 17, wherein the memory device further includes instructions executable by the processing device for causing the processing device to concurrently solving the system of quadratic functions by:
using a first quadratic function in the system of quadratic functions as a value for a variable in a second quadratic function in the system of quadratic functions; and
solving the second quadratic function.
